(19) United States
(12) Patent Application Publication
(10) Pub. No.: US 2013/0093891 A1
(43) Pub. Date: Apr. 18, 2013

(54) VEHICLE OCCUPANT DETECTORS

(71) Applicants: John Tyrer, Loughborough (GB); Leon Lobo, Loughborough (GB); John Jones, Loughborough (GB)

(72) Inventors: John Tyrer, Loughborough (GB); Leon Lobo, Loughborough (GB); John Jones, Loughborough (GB)

(73) Assignee: VEHICLE OCCUPANCY LIMITED, Leicestershire (GB)

(21) Appl. No.: 13/641,049

(22) PCT Filed: Apr. 7, 2011
(86) PCT No.: PCT/GB2011/050691

§ 371 Date: Dec. 26, 2012

(30) Foreign Application Priority Data
Apr. 13, 2010 (GB) 1006052.3

(51) Int. Cl. H04N 5/33

(52) U.S. Cl. CPC H04N 5/33
USPC 348/148

(57) ABSTRACT

In the field of vehicle occupant detectors there is a need for an improved vehicle occupant detector which is able to consistently identify the number of occupants in vehicles having windscreens with different infrared transmission characteristics. A vehicle occupant detector comprises a first infrared illuminator that is operable at a first infrared wavelength to illuminate an interior of a vehicle, and a second infrared illuminator that is operable at a second infrared wavelength to illuminate an interior of a vehicle. The vehicle occupant detector also includes a first infrared detector to capture a first image of the interior of the vehicle illuminated at the first infrared wavelength, and a second infrared detector to capture a second image of the interior of the vehicle illuminated at the second infrared wavelength. The first and second infrared detectors have the same infrared detection characteristics.

This invention relates to a vehicle occupant detector and a method of identifying one or more occupants in a vehicle.

It is known from WO 2008/099146 to provide a vehicle occupant detector which includes first and second infrared illuminators to illuminate the interior of a vehicle at different infrared wavelengths. According to WO 2008/099146 a first preferred infrared wavelength lies in the range 1400 nm to 1600 nm while a second preferred infrared wavelength lies in the range 800 nm to 900 nm.

The vehicle occupant detector known from WO 2008/099146 also includes first and second infrared detectors to capture respective images of the interior of the vehicle within each of the first and second preferred ranges of infrared wavelengths.

WO 2008/099146 teaches that the first infrared detector should be an infrared camera while the second infrared detector should be a silicon video camera capable of capturing an image within the wavelength range of 300 nm to 1000 nm.

The inclusion of a video camera as a second infrared detector reduces the cost of the vehicle occupant detector, while operating in the lower infrared frequency range of 800 nm to 900 nm provides a good contrast between the extent to which human skin reflects infrared in this range and the extent to which other organic/inorganic materials (e.g. cabbages, plastics, clothing) reflect infrared in this range.

WO 2008/099146 indicates that good contrast between the infrared reflection characteristics of human skin and such other organic/inorganic materials is important so that the vehicle occupant detector can distinguish between such materials when seeking to detect the number of occupants in a vehicle.

However, one drawback with the vehicle occupant detector of WO 2008/099146 is that it has difficulty consistently identifying the number of occupants in vehicles having windscreens with differing infrared transmission characteristics. Since the transmission characteristics of a windscreen can vary according to the make and model of vehicle, as well as when the vehicle was manufactured, this inconsistency means that the vehicle occupant detector of WO 2008/099146 is wholly unsuitable for a practical application in which the windscreen of each successive vehicle observed potentially has a different infrared transmission characteristic.

There is, therefore, a need for an improved vehicle occupant detector that is able to consistently identify the number of occupants in a full range of vehicles having windscreens with differing infrared transmission characteristics.

According to a first aspect of the invention there is provided a vehicle occupant detector comprising:
a first infrared illuminator operable at a first infrared wavelength to illuminate an interior of a vehicle;
a second infrared illuminator operable at a second infrared wavelength to illuminate an interior of a vehicle;
a first infrared detector to capture a first image of the interior of the vehicle illuminated at the first infrared wavelength; and
a second infrared detector to capture a second image of the interior of the vehicle illuminated at the second infrared wavelength,
the first and second infrared detectors having the same infrared detection characteristics.

The inclusion of first and second infrared detectors having the same detection characteristics eliminates any differences in the first and second images arising from the manner in which the scattered infrared is detected, and so minimises the effect that varying infrared transmission characteristics from one windscreen to another has on the captured images. Eliminating such detection differences helps the vehicle occupant detector of the invention to consistently identify human occupants irrespective of the windscreen type in the vehicle.

Optionally the first and second infrared detectors are two identical, separate detector units. Such an arrangement ensures that the first and second infrared detectors have the same detection characteristics while providing flexibility in the relative arrangement of the two detectors.

Preferably the first and second infrared detectors occupy discrete portions of a single detector unit. The inclusion of a single detector unit ensures consistency in the performance of the two infrared detectors while significantly reducing the cost of producing the vehicle occupant detector.

The single detector unit may include a first group of pixels defining the first infrared detector and a second group of pixels defining the second infrared detector. Such an arrangement provides a ready way of detecting first and second infrared wavelengths using a single detector unit.

In a preferred embodiment of the invention the pixels in the first group lie diagonally adjacent to one another and the pixels in the second group lie diagonally adjacent to one another and adjacent to the pixels in the first group. Arranging the pixels in this manner allows use of the whole detector unit for detecting the infrared wavelengths.

Optionally the pixels in the first group lie in one half of the single detector unit and the pixels in the second group lie in the other half of the single detector unit.

The halves of the single detector unit may lie, in use, above and below one another.

Such features allow the shape of each of the first and second groups of pixels to correspond to the typical aspect ratio, i.e. shape, of a vehicle windscreen.

In another preferred embodiment of the invention the vehicle occupant detector further includes a processing module to:
determine the ratio of detected infrared in corresponding areas of the first and second images; and
identify human skin in a respective area when the ratio of detected infrared in the said respective area lies within a desired range.

The inclusion of such a processing module allows the vehicle occupant detector to determine the ratio of detected infrared in corresponding areas of the first and second images. Changes in infrared transmission characteristics from one windscreen to another have a similar effect on each of the first and second infrared wavelengths and so the determined ratio will be largely unaffected by such changes. As a result the ability of the vehicle occupant detector to identify human skin is unaffected by changes in windscreen infrared transmission characteristics and so the vehicle occupant detector is even more able consistently to identify human occupants in a vehicle.

In a further preferred embodiment of the invention the first infrared wavelength lies in the range 1400 nm to 1600 nm and the second infrared wavelength lies in the range 1000 nm to 1200 nm.

Utilising a second infrared wavelength in the range 1000 nm to 1200 nm reduces the contrast between the infrared reflection characteristics of human skin and organic materials because human skin reflects less infrared at this wavelength. However, moving the second range of infrared wavelengths closer to the first range of infrared wavelengths, than is the case in known vehicle occupant detectors, reduces still further any difference in the effect that changes in infrared transmission characteristics from one windscreen to another have on the first and second wavelengths. Consequently the vehicle occupant detector is further isolated from the differing effects on infrared transmission of different windscreens, and so the consistency with which the vehicle occupant detector is able to identify human occupants in a vehicle is further improved.

According to a second aspect of the invention there is provided a method of detecting one or more occupants in a vehicle comprising the steps of:
(a) illuminating an interior of the vehicle at a first infrared wavelength;
(b) illuminating the interior of the vehicle at a second infrared wavelength;
(c) capturing a first image of the interior of the vehicle illuminated at the first infrared wavelength with a first infrared detector; and
(d) capturing a second image of the interior of the vehicle illuminated at the second infrared wavelength with a second infrared detector,
the first and second infrared detectors having the same infrared detection characteristics.

Optionally detecting one or more occupants in a vehicle further includes the steps of:
(e) determining the ratio of detected infrared in corresponding areas of the first and second images; and
(f) identifying human skin in a respective area when the ratio of detected infrared in the said respective area lies within a desired range.

In a preferred embodiment of the invention determining the ratio of detected infrared in corresponding areas of the first and second images includes determining the ratio of detected infrared in corresponding pixels of the first and second images, and identifying human skin in a respective area includes identifying human skin in a respective pixel when the ratio of detected infrared in the said respective pixel lies within a desired range.

The method of the invention shares the advantages of the corresponding features of the vehicle occupant detector of the invention.

There now follows a brief description of a preferred embodiment of the invention, by way of non-limiting example, with reference being made to the accompanying drawings in which:

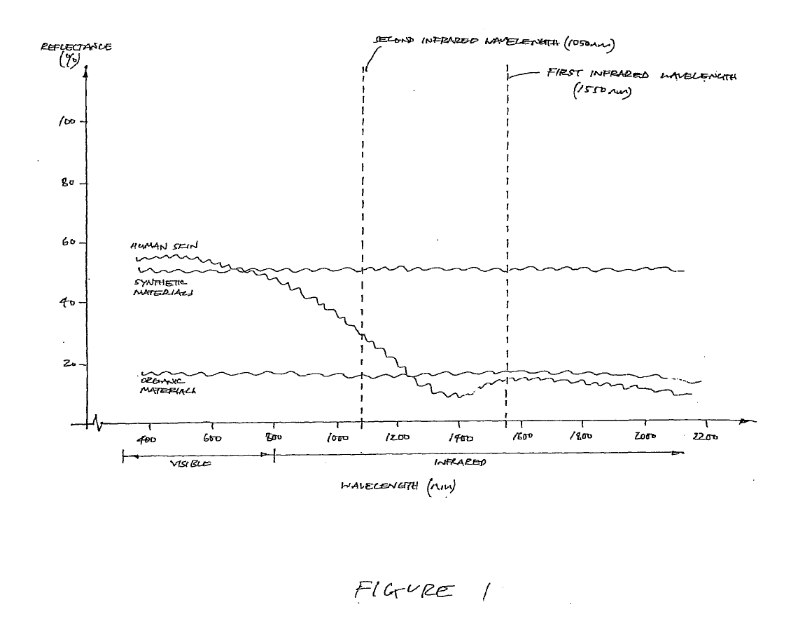

FIG. 1 illustrates schematically how the extent to which various materials reflect electromagnetic radiation varies according to the wavelength of the electromagnetic radiation;

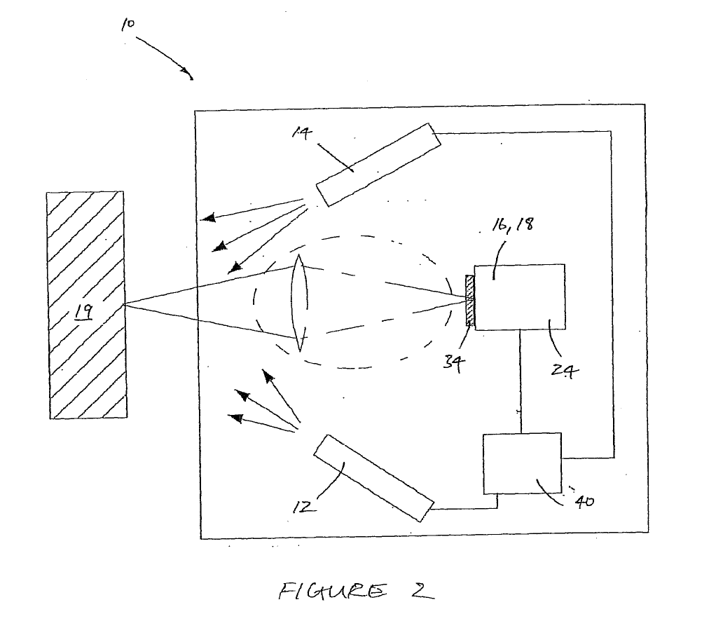

FIG. 2 shows a schematic view of a vehicle occupant detector according to a first embodiment of the invention;

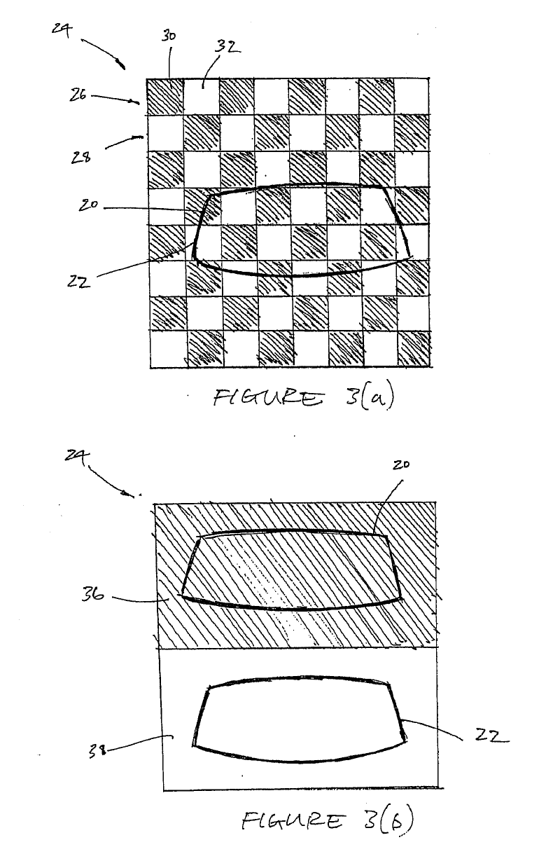

FIG. 3(a) shows a first arrangement of first and second groups of pixels in an infrared detector unit;

FIG. 3(b) shows a second arrangement of first and second groups of pixels in an infrared detector unit;

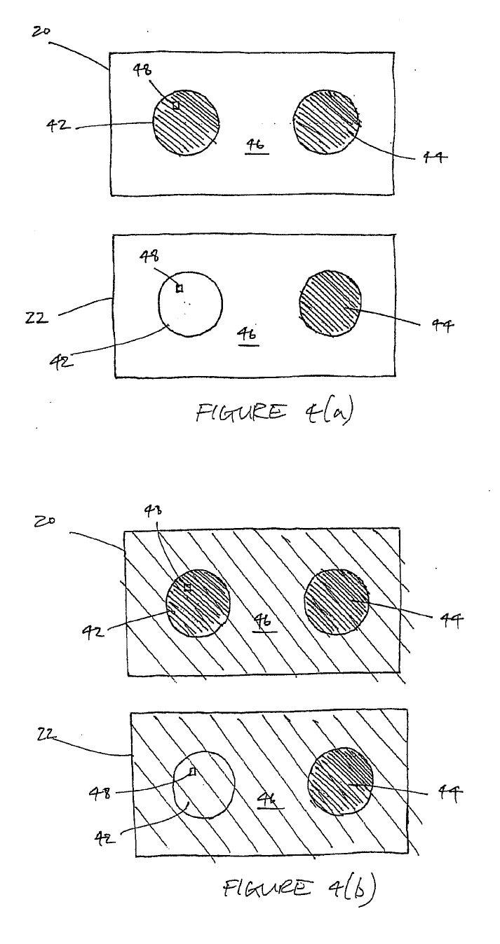

FIG. 4(a) illustrates schematically first and second images captured through a first windscreen;

FIG. 4(b) illustrates schematically first and second images captured through a second windscreen having different infrared transmission characteristics to the first windscreen; and

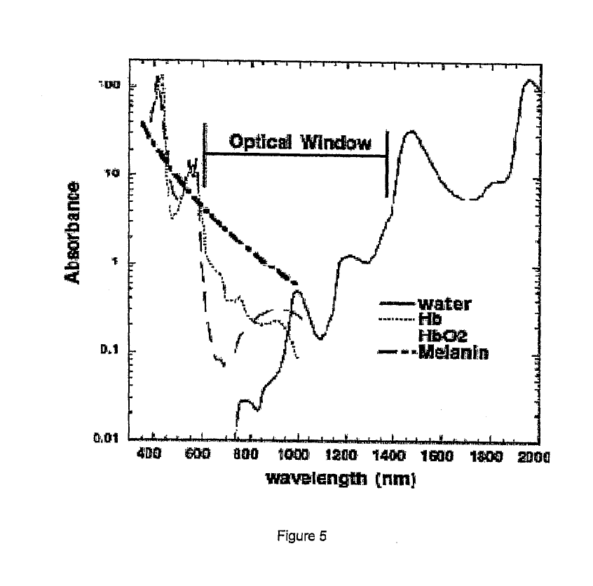

FIG. 5 illustrates schematically the infrared absorption characteristics of various constituents of human skin.

A vehicle occupant detector according to a first embodiment of the invention is designated generally by the reference numeral 10.

The vehicle occupant detector 10 includes a first infrared illuminator 12 which operates at a first infrared wavelength of 1550 nm. Other embodiments of the invention (not shown) may include a first infrared illuminator 12 that operates at an infrared wavelength in the range 1400 nm to 1600 nm.

The vehicle occupant detector 10 also includes a second infrared illuminator 14 which operates at 1050 nm. Other embodiments of the invention (not shown) may include a second infrared illuminator 14 that operates at an infrared wavelength in the range 1000 nm to 1200 nm, and still further embodiments of the invention may include one or more infrared illuminators that operate over a still further extended range.

Each of the first and second infrared illuminators 12, 14 is a laser.

In addition, the vehicle occupant detector 10 includes first and second infrared detectors 16, 18.

The first infrared detector 16 is arranged to capture a first image 20 of the interior of a vehicle 19 illuminated at the first infrared wavelength of 1550 nm, as shown schematically, for example, in FIGS. 4(a) and 4(b).

The second infrared detector 18 is arranged to capture a second image 22 of the interior of a vehicle 19 illuminated at the second infrared wavelength of 1050 nm, as also shown schematically in FIGS. 4(a) and 4 (b).

Each of the first and second infrared detectors 16, 18 have the same detection characteristics, i.e. each reacts to incident infrared radiation in the same way.

In the embodiment shown the first and second infrared detectors 16, 18 occupy discrete portions of a single detector unit 24. In particular, the single detector unit 24 includes first and second groups of pixels 26, 28 which respectively define the first and second infrared detectors 16, 18.

First pixels 30 in the first group of pixels 26 lie diagonally adjacent to one another and second pixels 32 in the second group of pixels 28 lie diagonally adjacent to one another and adjacent to the first pixels 30, as shown in FIG. 3(a).

In such an arrangement the detector unit 24 may include a filter 34, e.g. a narrow bandpass filter, configured to allow the transmission of only the first infrared wavelength (1550 nm) into each of the first pixels 30 and the transmission of only the second infrared wavelength (1050 nm) into the second pixels 32. Such a configuration means that the or each of the first and second pixels 30, 32 receives only the active illumination wavelength to maximise the contrast between human skin and surrounding materials.

The vehicle occupant detector is configured to generate separate first and second images 20, 22 of the interior of the vehicle from the data collected by the respective first and second groups of pixels 26, 28 by interpolating between adjacent pixels 30, 32 in each group 26, 28.

A suitable single detector unit 24 is a single Indium Gallium Arsenide (InGaAs) detector.

In other embodiments of the invention the first pixels 30 may lie in one half of the detector unit 24, the second pixels 32 lie in the other half of the detector unit 24, and the respective halves lie one above the other, as shown in FIG. 3(b). Such an arrangement allows, e.g. the upper half 36 of the detector unit 24 to capture the first image 20 of the interior of a vehicle at the first infrared wavelength, and the lower half 38 to capture the second image 22 of the interior of the vehicle at the second infrared wavelength.

In still further embodiments of the invention (not shown) the first and second infrared detectors 16, 18 may be two identical, separate detector units.

The vehicle occupant detector 10 shown also includes a processing module 40 to determine the ratio of detected infrared in corresponding areas of the first and second images 20, 22, and to identify human skin in a respective area when the ratio of detected infrared in the said respective area lies within a desired range.

In particular, the processing module 38 determines the ratio of detected infrared in corresponding pixels 30, 32 of the first and second images 20, 22, and identifies human skin in a respective pixel 30, 32 when the ratio of detected infrared in the said respective pixel 30, 32 lies within a desired range.

The desired range may be less than or greater than a predetermined threshold, or determined in some other manner.

In other embodiments of the invention, the processing module 40 may identify human skin a respective area by performing a different arithmetic operation or a logical operation on the infrared detected in the said respective area of the first and second images 20, 22.

In use, the first infrared detector 16, i.e. the first group of pixels 26 in the detector unit 24, captures a first image 20 of the interior of a first vehicle which is illuminated at the first infrared wavelength of 1550 nm, as shown schematically in FIG. 4(a).

As illustrated schematically in FIG. 1, both human skin and green organic matter exhibit low reflectance of infrared at this wavelength, and so each of a human head 42 and a green organic object, such as a cabbage 44, appear dark in the image 20 because only low levels of the incident infrared radiation (at a wavelength of 1550 nm) are scattered back to the first infrared detector 16. In particular, at a wavelength of 1550 nm water in human skin is highly absorbing of infrared and predominates over other skin constituents, as illustrated schematically in FIG. 5.

In the meantime synthetic materials 46 in the interior of the vehicle exhibit a greater degree of reflectance than human skin and green organic matter, and so appear light in the image 20 because more of the incident infrared radiation (at a wavelength of 1550 nm) is reflected.

At the same time the second infrared detector 18, i.e. the second group of pixels 26 in the detector unit 24, captures a second image 22 of the interior of the vehicle which is illuminated at the second infrared wavelength of 1050 nm.

At this wavelength human skin exhibits greater reflectance than green organic matter, as do synthetic materials, and so the human head 42 and synthetic materials 46 appear light in the second image, while the cabbage 44 continues to appear dark. In particular, at a wavelength of 1050 nm haemoglobin (Hb and HbO2) and melanin in human skin reflect more infrared than they do at, say 808 nm, and so predominate, even though water in human skin absorbs more infrared at 1050 nm than it does at, say 808 nm, as illustrated schematically in FIG. 5.

The processing module 40 then determines the ratio of detected infrared in corresponding pixels of the first and second images 20, 22 and identifies human skin in a respective pixel 30, 32 when the ratio of detected infrared in the said respective pixel 30, 32 lies within a desired range.

For example, the processing module 40 establishes the amount of reflected infrared at the first wavelength of 1550 nm detected at a given pixel 48 in the first image 20 and the amount of reflected infrared at the second wavelength of 1050 nm at the same given pixel 48 in the second image 22.

The processing module 40 may then determine the ratio of detected infrared at this pixel 48 by dividing the detected amount of reflected first wavelength infrared by the detected amount of reflected second wavelength infrared to arrive at a first ratio value R₁.

If this first ratio value R₁ is, e.g. smaller than, a predetermined threshold value then the processing module 40 identifies the given pixel 48 as relating to human skin.

Depending on the number and arrangement of adjacent pixels which have been determined to relate to human skin the processing module 40 is able to identify a human head, and hence a vehicle occupant.

FIG. 4(b) illustrates schematically similar captured first and second images 20, 22 from a second vehicle which has a windscreen with different infrared transmission characteristics to the windscreen in the first vehicle and in particular, a windscreen that is a poorer transmitter of infrared than the windscreen of the first vehicle.

As shown in FIG. 4(b), the first and second infrared wavelengths are scattered by each of the elements of interest, i.e. human skin, organic material and synthetic materials, in a similar relative manner as in the first vehicle.

However, the windscreen of the second vehicle inhibits the transmission of infrared radiation, and so attenuates the amount of reflected infrared radiation that reaches the first and second infrared detectors 16, 18.

Nevertheless, because the first and second infrared detectors 16, 18 have the same detection characteristics, and because the first and second infrared wavelengths are relatively close to one another in the electromagnetic spectrum, the windscreen attenuation has an essentially uniform effect on the first and second images 20, 22.

Consequently, the relative amount of reflected infrared radiation detected in a given pixel 48 in each image 20, 22, and hence the ratio R₂ of detected infrared in each image 20, 22, remains essentially the same. Accordingly, since R₂ essentially equals R₁, the vehicle occupant detector 10 is able to discern human skin in the same manner as with the first vehicle, despite the differing infrared transmission characteristics of the windscreen in the second vehicle. The vehicle occupant detector is, therefore, able to consistently identify vehicle occupants irrespective of the nature of the windscreen in a vehicle.

1. A vehicle occupant detector comprising:
a first infrared illuminator operable at a first infrared wavelength to illuminate an interior of a vehicle;
a second infrared illuminator operable at a second infrared wavelength to illuminate an interior of a vehicle;
a first infrared detector to capture a first image of the interior of the vehicle illuminated at the first infrared wavelength; and
a second infrared detector to capture a second image of the interior of the vehicle illuminated at the second infrared wavelength,
the first and second infrared detectors having the same infrared detection characteristics.

2. A vehicle occupant detector according to claim 1 wherein the first and second infrared detectors are two identical, separate detector units.

3. A vehicle occupant detector according to claim 1 wherein the first and second infrared detectors occupy discrete portions of a single detector unit.

4. A vehicle occupant detector according to claim 3 wherein the single detector unit includes a first group of pixels defining the first infrared detector and a second group of pixels defining the second infrared detector.

5. A vehicle occupant detector according to claim 4 wherein the pixels in the first group lie diagonally adjacent to one another and the pixels in the second group lie diagonally adjacent to one another and adjacent to the pixels in the first group.

6. A vehicle occupant detector according to claim 4 wherein the pixels in the first group lie in one half of the single detector unit and the pixels in the second group lie in the other half of the single detector unit.

7. A vehicle occupant detector according to claim 6 wherein the halves of the single detector unit lie, in use, above and below one another.

8. A vehicle occupant detector according to claim 1 further including a processing module to:
determine the ratio of detected infrared in corresponding areas of the first and second images; and
identify human skin in a respective area when the ratio of detected infrared in the said respective area lies within a desired range.

9. A vehicle occupant detector according to claim 1 wherein the first infrared wavelength lies in the range 1400 nm to 1600 nm and the second infrared wavelength lies in the range 1000 nm to 1200 nm.

10. A method of detecting one or more occupants in a vehicle comprising the steps of:
(a) illuminating an interior of the vehicle at a first infrared wavelength;
(b) illuminating the interior of the vehicle at a second infrared wavelength;
(c) capturing a first image of the interior of the vehicle illuminated at the first infrared wavelength with a first infrared detector; and
(d) capturing a second image of the interior of the vehicle illuminated at the second infrared wavelength with a second infrared detector,
the first and second infrared detectors having the same infrared detection characteristics.

11. A method of detecting one or more occupants in a vehicle according to claim 10 further including the steps of:
(e) determining the ratio of detected infrared in corresponding areas of the first and second images; and
(f) identifying human skin in a respective area when the ratio of detected infrared in the said respective area lies within a desired range.

12. A method of detecting one or more occupants in a vehicle according to claim 11 wherein determining the ratio of detected infrared in corresponding areas of the first and second images includes determining the ratio of detected infrared in corresponding pixels of the first and second images, and identifying human skin in a respective area includes identifying human skin in a respective pixel when the ratio of detected infrared in the said respective pixel lies within a desired range.

13. (canceled)

14. (canceled)
